(19) United States
(12) Patent Application Publication
(10) Pub. No.: US 2013/0014415 A1
(43) Pub. Date: Jan. 17, 2013

(54) MOUNT FOR DISPLAY ITEM

(71) Applicants: Mark Morrish, Powys (GB); John Morrish, Powys (GB)

(72) Inventors: Mark Morrish, Powys (GB); John Morrish, Powys (GB)

(21) Appl. No.: 13/548,645

(22) Filed: Jul. 13, 2012

(30) Foreign Application Priority Data
Jul. 15, 2011 (GB) 1112178.7

(51) Int. Cl. A47G 1/06; B32B 38/00; B32B 38/10

(52) U.S. Cl. 40/773; 156/249; 156/227

(57) ABSTRACT

A mounting system for receiving a display item for display, comprising a display item receiving surface for receiving an item to be displayed, a release layer arranged on the receiving surface including first and second adjacent foldable portions arranged in a first configuration, and an adhesive layer interposed between the receiving surface and the release layer, wherein, when arranged in a second configuration, the first and second portions expose a first region of the adhesive layer and define a mounting support for the display item.

### BACKGROUND

Photographs and other memorabilia can be displayed by mounting or otherwise posting such items on appliances, walls, furniture, cork boards and other such similar surfaces.

It has recently become popular for items to be displayed, in particular images such as photographs for example, to be mounted directly on a board or canvas, in a minimalistic way, a so that no frame or glass impinges upon the display. In certain instances, the image may be directly printed onto the canvas for example, which can then be directly mounted onto a simple box frame, such as by stretching the canvas over the frame, and stapling it to the inside of the frame to secure it in place. However, the techniques and apparatus currently available to achieve such a look typically involve specialist skills and equipment and sometimes include bulky laminating equipment both for the creation of the mounting surface and also to ensure the accurate placement of the item to be displayed on the surface without introducing creases or air bubbles.

### SUMMARY

According to a first aspect, there is provided a mounting system for receiving a display item for display, comprising a display item receiving surface for receiving an item to be displayed, a release layer arranged on the receiving surface including first and second adjacent foldable portions arranged in a first configuration and an adhesive layer interposed between the receiving surface and the release layer, wherein, when arranged in a second configuration, the first and second portions expose a first region of the adhesive layer and define a mounting support for the display item. The release layer can further include a third portion.

In an example, a boundary between the first and second foldable portions is perforated or creased, and a boundary between the second and third portions is perforated or creased. The foldable portions can be folded back exposing a corresponding region of the adhesive layer, and at least a part of the first foldable portion can extend over the periphery of the receiving surface.

In an example, the adhesive layer extends to the periphery of the receiving surface. A boundary region can extend around at least a portion of the periphery of the receiving surface and be substantially devoid of adhesive. The boundary region can be between 1-5 mm in width, and may be 2 mm in width according to an example. The receiving surface is a substantially rigid substrate formed form a material selected from cardboard, wood, fibreboard, chipboard, plastics material ceramic and glass.

According to a second aspect there is provided a method of mounting a display item on a receiving surface with an adhesive layer provided thereon and including a releasable layer disposed over the adhesive layer including first and second flap portions, the method comprising separating the second flap portion of the releasable layer from the adhesive using the first flap portion to expose a first region of adhesive, mounting the display item on the receiving surface using the first region of adhesive, separating the remainder of the releasable layer from the adhesive using the first or second flap portions to expose a second region of adhesive, and securing the display item to the receiving surface using the second region of adhesive.

In an example, separating the second flap portion can include folding the first and/or second flap portions to provide an elevated region adjacent the first region of adhesive onto which the display item can rest without touching the exposed adhesive of the first region. Mounting the display item includes adhering a portion of the item to the first region of adhesive, and separating the second flap portion includes folding the second flap portion using a perforated region at the boundary of the second flap portion with the remainder of the releasable layer. In an example, separating the second flap portion of the releasable layer from the adhesive using the first flap portion includes using at least a part of the first flap portion which extends over the periphery of the receiving surface.

According to a third aspect there is provided a mount for a display item, comprising a substantially rigid substrate including an adhesive layer disposed over a portion of a face thereof, a releasable layer covering the adhesive and including first and second perforated boundaries defining three portions for the backing layer, at least one arranged to expose a portion of the adhesive layer when separated from the adhesive layer, and wherein one backing layer portion extends over an edge of the face.

In an example, the mount can include a boundary region on the periphery of the substrate which is devoid of the adhesive layer. At least one portion of the backing material is arranged to expose a portion of the adhesive layer which can be further arranged to be folded back to provide a raised area for receiving the display item for alignment on the mount. The first perforated boundary is provided on the one backing layer portion which extends over an edge of the face so that the portion can be folded down over the edge, and the three portions can have respective different sizes. For example, a first portion can have a smaller area than a second portion which has a smaller area than a third portion. Other alternatives are possible.

### BRIEF DESCRIPTION OF THE DRAWINGS

An embodiment of the invention will now be described, by way of example only, and with reference to the accompanying drawings, in which:

FIG. 1 is a diagram of a mount system according to an example;

FIG. 2 is a diagram of a mount system according to an example;

FIG. 3 is a side on view of a mount according to an example; and

FIGS. 4a-4f are side on views of a mount system in use according to an example.

### DETAILED DESCRIPTION

There is an increasing demand to mount display items or images directly onto a board of significant thickness (such as from 12 to 25 mm for example) which can then be displayed on a wall or flat surface. This can be done by laminating an image, photo, or picture larger than the mounting board onto the board and trimming off any excess image. In some instances the mounting board may already be covered by a self adhesive surface to which the image is applied. However currently there is no simple way for an image to be quickly mounted onto a base board of correct sized without trimming or risking miss-alignment, and/or air bubbles under the surface of a print. Increasingly, individuals, photographers and retail photo-kiosk operators desire a fail-safe method of quickly (such as of the order of 30 seconds for example) mounting a photo-image onto a pre-finished block mount of a correct size.

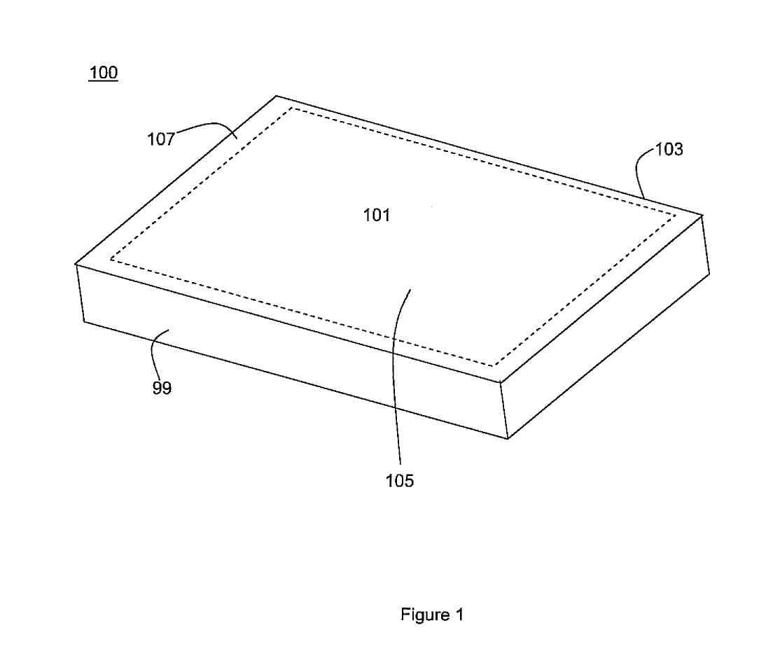

FIG. 1 is a diagram of a mount system comprising a mount 100 according to an example. The mount 100 can be in the form of a substrate portion 99 made from a sheet of milled medium density fibreboard (MDF) or similarly rigid material such as cardboard, wood, chipboard, plastics materials and glass for example, and comprises a first surface 101 having a perimeter 103. The first surface 101 is a planar surface the perimeter 103 of which is rectangular in shape, although it will be appreciated that the planar surface may be any desired shape. According to an example, the first surface 101 comprises a first area 105 and a second area 107. The first area 105 is provided with a layer of adhesive material (not shown). The second area 107 is adhesive-free. The second area 107 is adjacent the perimeter 103 of the first surface 101 and forms a peripheral border around the first area 105. In an example, the second area can be between 1 and 5 mm in width. The second area 107 can be provided as a result of edging being applied to the substrate to form the mount 100. For example, in the case of a substrate portion 99 for a mount made from MDF, it can be desirable to edge the portion with an edging material such as a rubber or plastic edging material in order to improve the finish and durability of the mount 100. The edging material may be devoid of adhesive material, thereby forming the second area 107 on the first surface 101. Alternatively, adhesive material may be applied over any edging material applied to the substrate portion (or over the entirety of the substrate portion in the absence of any edging material) to form a single area (not shown) which is substantially covered in adhesive material with no second area 107. For the sake of clarity, in the description which follows in connection with the figures, a second area around the periphery of the mount is provided. However, it should be noted that a second area may not be provided, in which case an adhesive layer may extend to the edges of the first surface 101.

The adhesive free section 107 around the edge of the mount 100 enables a tolerance to the size of print which can be mounted on the mount. Typically, the normal method for mounting a print on a substrate is to have an undersized block and after laying down the print it has to be trimmed to fit the block. This is time consuming and involves the use of very sharp knives; neither of which are practical or sometimes possible in a busy environment.

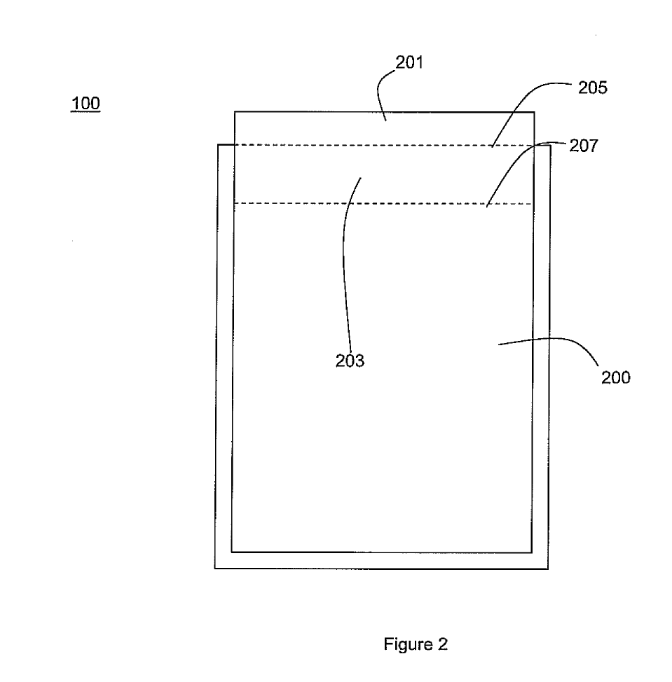

Referring to FIG. 2, which is a diagram of a mount system according to an example, mount 100 is provided with a release layer arrangement 200 which is removably located upon the surface of the adhesive material. The adhesive can be a layer of thin double sided adhesive, with one side being adhered to a face of the mount substrate 99 such as first surface 101, and the other side being adhered to the release Layer in order to prevent it from becoming stuck to things when not desired. The release layer arrangement can thus comprise a sheet of material such as a silicon release paper for example, however it will be appreciated that any other suitable release paper such as silicone coated material or wax coated paper or the like could be used as an alternative. In an example, the release layer sheet arrangement extends over the entirety of first area 105. It can also extend over the second area 107 if that area exists to provide cover and protection (even if there is no adhesive present in area 107). For example, if the adhesive layer extends over the entirety of the first surface 101 including second area 107, the release layer can similarly extend over all adhesive in order to prevent unwanted sticking. Alternatively, a release layer can extend only over first area 105, particularly if there is no adhesive in area 107.

A first foldable portion 201 of the release layer 200 is provided which extends beyond an edge of the mount 100. A second foldable portion 203 is provided. The intersection or boundary 205 between the first and second portions of the release layer can be provided with a mechanism to ease folding of the portions with respect to one another such as by providing a crease, indentation or perforations along the entirety or a portion of the length of the intersections. An intersection 207 between the second portion and the remainder of the release layer can be similarly creased, indented or perforated. Note that boundaries 205 and 207 can have respective different mechanisms to ease folding.

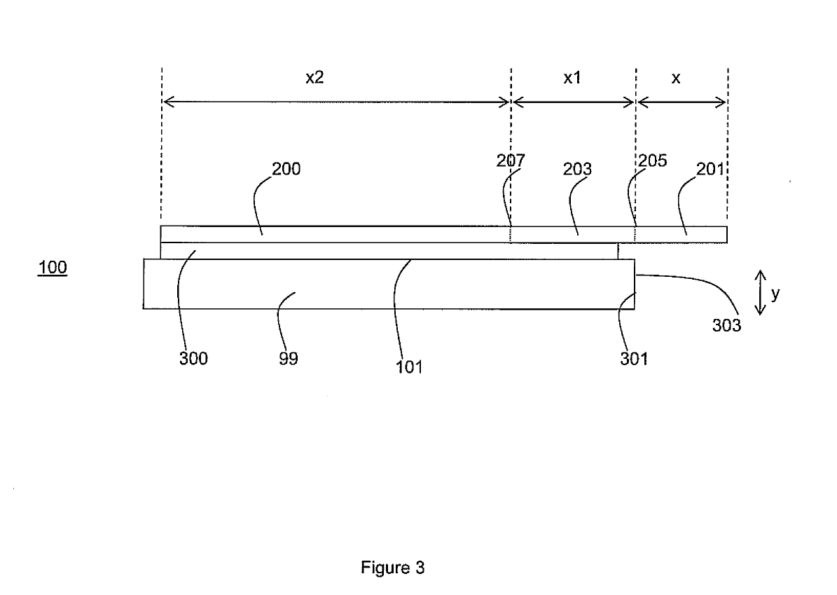

FIG. 3 is a side on view of a mount 100 according to an example. The first surface 101 of the substrate 99 of mount 100 defines a receiving surface for receiving a display item to be mounted on the mount 100. The adhesive layer 300 is depicted on the receiving surface in order to enable a display item to be mounted to be adhered to the mount 100. Release or releasable layer 200 is depicted. Specifically, releasable layer 200 covers the adhesive layer 300, and includes a first foldable portion 201 of length x which extends out over the edge of the mount 100. An intersection 205 between the first portion 201 and the second portion 203 is provided substantially in fine with the edge 301 of the mount. In this way, first portion 201 can be folded flush with face 303 of mount 100 to enable the mount to be packaged and/or stored in a way which reduces the chance of portion 201 being torn off or becoming otherwise damaged. In an example, the length x of portion 201 can be substantially the same or less than the width y of the face 303 of mount 100 to prevent any of portion 201 protruding from face 303 when folded down. In an example, portion 201 is smaller than portion 203 (of length x1) which is in turn smaller than the remainder of the release layer 200 (of length x2). That is to say, the area of the portions can vary, or depending on mount dimensions, the values for the lengths of x, x1 and x2 can follow x<x1<x2. Other alternatives are possible such as x=x1=x2, or any other suitable combination.

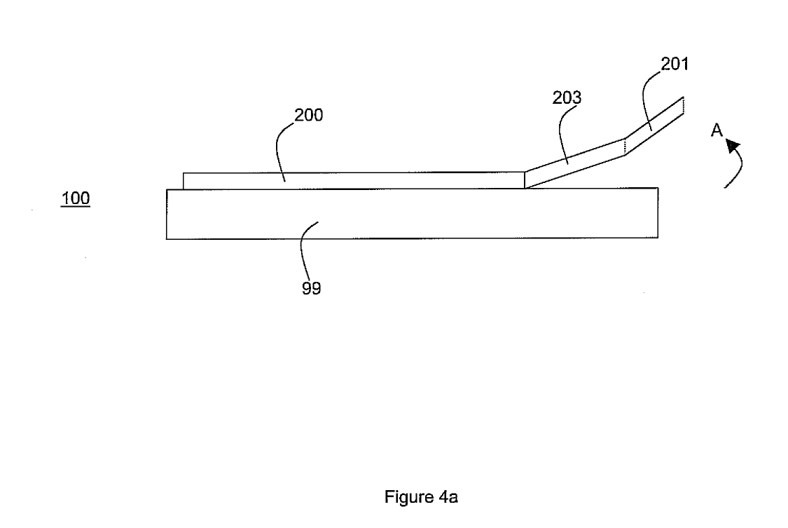

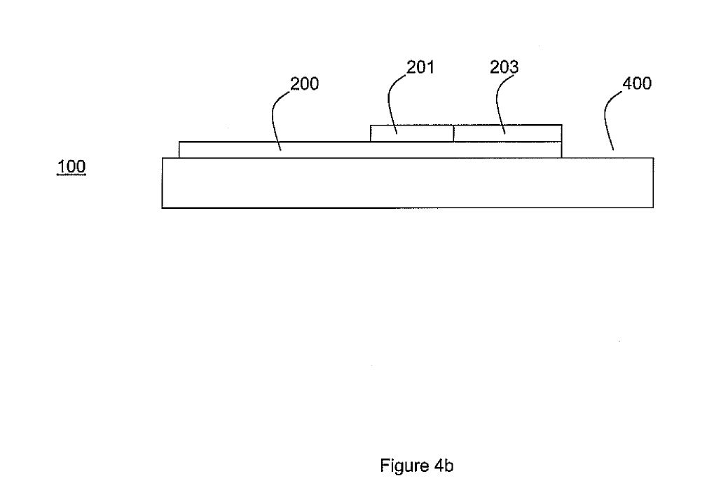

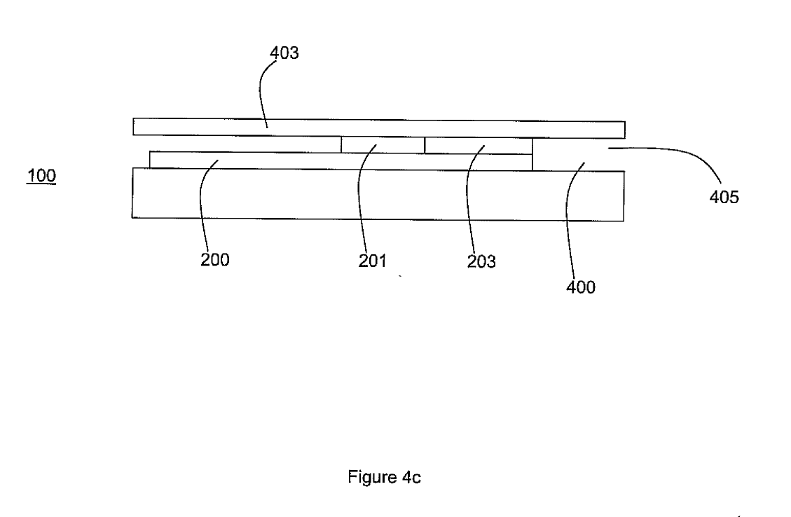

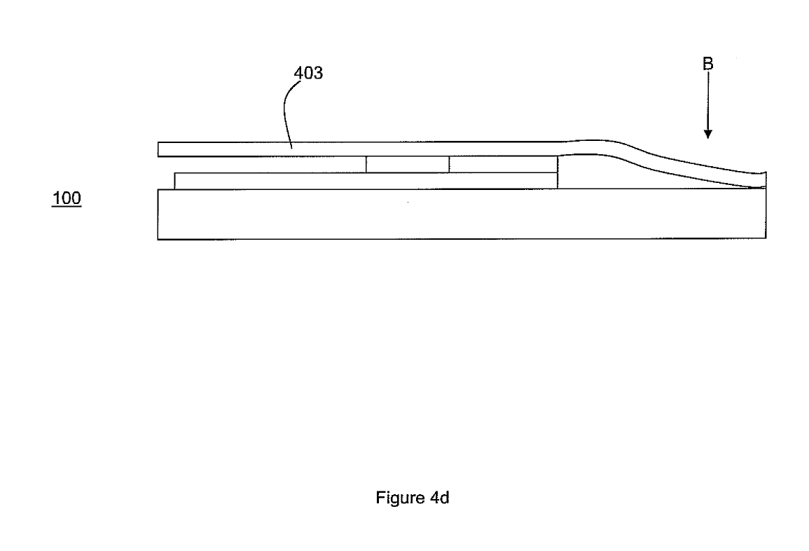

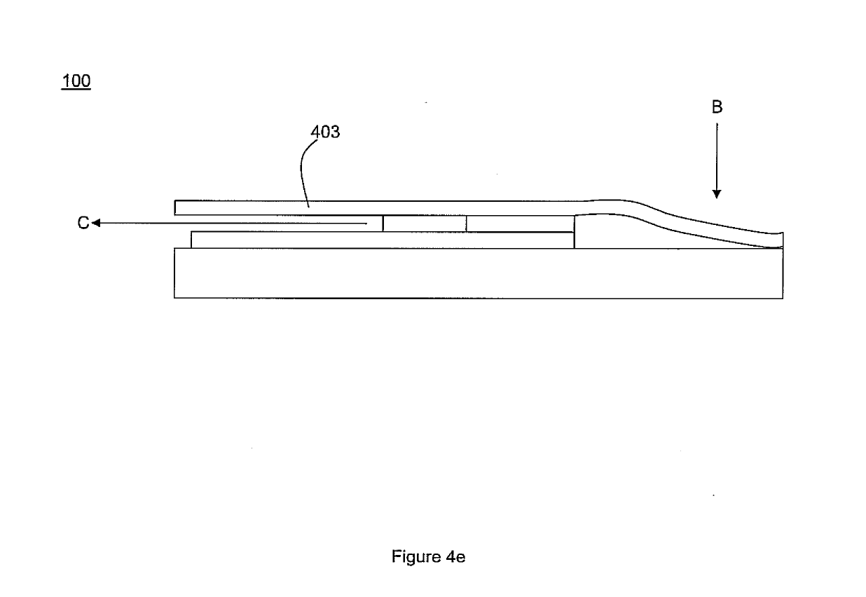

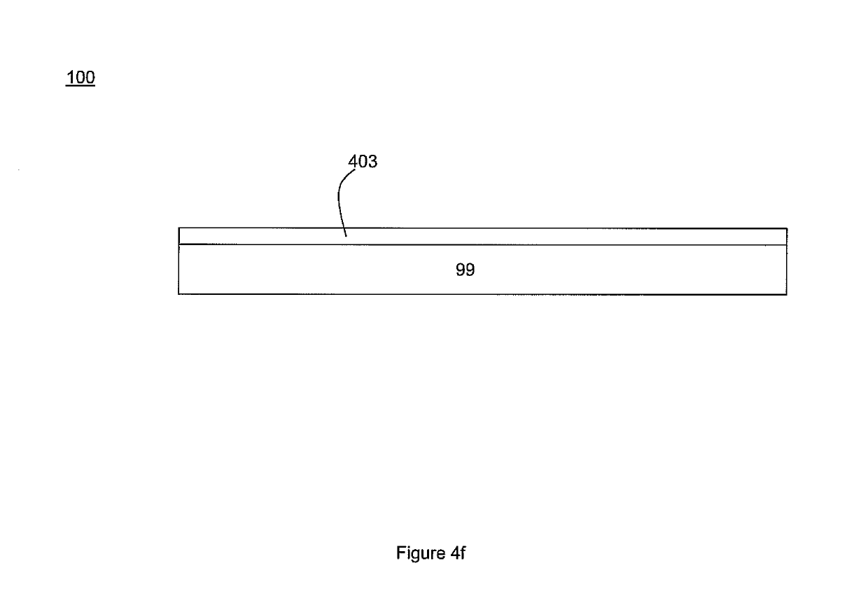

FIGS. 4a-4f are side on views of a mount system in use according to an example. In FIG. 4a, the mount 100 is shown with flap portions 201, 203 having been separated from the adhesive layer by pulling on the flap portion 201 generally in the direction shown by arrow A, that is, away from the substrate 99 so as to separate the flap portions therefrom. Either or both of the flap portions may be separated in this way. In FIG. 4b, the flap portions 201, 203 are folded back as shown and an exposed area 400 of adhesive is therefore provided. According to an example, and as shown in FIG. 4b, the flap portions 201, 203 can be folded back so that they are substantially flush with the remainder of the release layer 200. Alternatively, and as a result of the resilient nature of the release layer for example, the flap portions 201, 203 can be folded back but not lie flush with the remainder 200. Accordingly, there can be a small gap therebetween, which does not affect the use of the mount system 100.

In FIG. 4c, a display item 403 which is to be mounted on the mount 100 is shown. Item 403 is arranged on mount 100 and comes into contact with at least flap portions 201, 203 but may also contact the remainder of the release layer 200. The item 403 is held above the exposed portion of adhesive 400 by a small gap 405. The gap 405 exists by virtue of the fact that the release layer is now thicker along at least a portion of its length because flap portions 201, 203 have been folded back as shown. According to an example, the disposition of the intersections 205, 207 can be such as to ensure that the folded back flap portions 201, 203 occur over a first half of the mount 100 so as to ensure that, when in contact with those portions, a display item 403 to be mounted is biased so that its far end will contact the remainder of the release layer 200 rather than the exposed adhesive portion 400. That is to say, the disposition of the flap portions 201, 203 when in their folded back positions can be such so as to act as a fulcrum for the item 403 which ensures that it will not come into contact with the exposed adhesive layer unless a force is manually applied (assuming that the articles are maintained in a substantially horizontal orientation as shown). When folded back, portions 201, 203 thus form a mounting support for a display item 403 which serves to hold the item 403 aloft from the exposed adhesive portion 400 so that it does not adhere without a manual intervention. This permits alignment of the item 403 before it is mounted. Thus, folding the first and/or second flap portions 201, 203 provides an elevated region adjacent the first exposed region of adhesive 400 onto which the display item 403 can rest without touching the exposed adhesive of the first region.

In FIG. 4d, the display item 403 is mounted on mount 100 by applying pressure to the item to secure it to the exposed adhesive portion 400. For example, applying pressure in the direction shown generally by arrow B will result in the item coming into contact with the exposed adhesive portion 400 and sticking thereto. According to an example, mounting the display item 403 by sticking it to the exposed adhesive portion 400 includes aligning the item 403 prior to applying pressure in direction B in order to ensure that, once adhered, it is in a desired location and orientation on the mount. In an example, a low tack adhesive can be used which can enable any errors in alignment to be corrected by making it possible to remove the item 403 from the exposed portion 400 if it has been misaligned without causing damage to the display item 403 or the mount 100.

In FIG. 4e, release layer 200 is removed by pulling it generally in the direction shown by arrow C. This has the effect of separating the release layer from the adhesive layer on the mount. The release layer can be separated by pulling one or both of the flap portions 201, 203, thereby exposing a second region of the adhesive layer which was previously covered by the remainder of the release layer 200. According to an example, the display item can be secured to the mount by sticking it to the second exposed adhesive portion. This can be done during the separation of the release layer 200 from the mount, or following its removal. For example, pressure can be applied to the display item 403 contemporaneously with the removal of the release layer 200 from the mount so that any adhesive layer which is gradually exposed during the separation can be used to adhere a corresponding portion of the display item 403. In FIG. 4f, the display item 403 is shown secured to the mount 100 after having been secured to it using the second region of adhesive which was exposed during separation of the remainder of the release layer 200.

According to an example, the display item surface area is as large as or greater than that of the first surface 101 so that no adhesive is exposed when the display item 403 is affixed to the mount 100. Alternatively, the display item surface area can be as large as or greater than that of the first area 105.

Various modifications may be made to the examples hereinbefore described without departing from the scope of the invention. For example whilst the first surface 101 has been illustrated and described as being planar, it will be appreciated that it may be shaped in a variety of ways including but not limited to curved, stepped and textured. Similarly, the first surface 101 has been described and shown as defining a rectangle however it will be appreciated that the first surface 101 may define any one of a variety of shapes including but not limited to a circle, polygon or freeform shape. In addition, the mount 100 may be of any size to complement a display scheme or particular display item and the mount dimensions, as well as the first surface shape and profile, may be formed to suit such a requirement. The mount 100, and more specifically the substrate 99 have been described as being formed from milled MDF material, however any suitable material such as, but not limited to, cardboard, chipboard, wood, plastic, glass or ceramic may be used and finished in any desired manner prior to the provision of the adhesive material 300. Similarly, the adhesive material 300 has been described as being double sided adhesive tape. However, any suitable adhesive material such as suitable glue could be used.

Whilst the above embodiments have detailed the releasable layer 200 having a first foldable portion 201 which extends over a periphery of the mount 100, the release layer 200 may alternatively be provided with one or more tabs which protrude over the edge of the mount 100 and which are arranged to serve the same purpose as the flap 201. That is, the or each tab may be of suitable size and position to enable it to be used to expose a first portion 400 of adhesive, and to enable the provision of a gap 405 when folded back.

1. A mounting system for receiving a display item for display, comprising:
a display item receiving surface for receiving an item to be displayed;
a release layer arranged on the receiving surface including first and second adjacent foldable portions arranged in a first configuration; and
an adhesive layer interposed between the receiving surface and the release layer, wherein, when arranged in a second configuration, the first and second portions expose a first region of the adhesive layer and define a mounting support for the display item.

2. The mounting system of claim 1 wherein, the display item receiving surface includes a boundary region around its periphery devoid of adhesive layer.

3. The mounting system of claim 1, wherein the release layer further includes a third portion.

4. A mounting The mounting system of claim 1, wherein a boundary between the first and second foldable portions is perforated or creased.

5. The mounting system of claim 1, wherein a boundary between the second foldable portion and the third portion is perforated or creased.

6. The mounting system of claim 1, a foldable portion for exposing a corresponding region of the adhesive layer.

7. The mounting system of claim 1, wherein at least a part of the first foldable portion extends over the periphery of the receiving surface.

8. The mounting system of claim 1, wherein the adhesive layer extends to the periphery of the receiving surface.

9. (canceled)

10. The mounting system of claim 2, wherein the boundary region is between 1-5 mm in width.

11. The mounting system of claim 1, wherein the receiving surface is a substantially rigid substrate formed form a material selected from cardboard, wood, fibreboard, chipboard, plastics material and glass.

12. A method of mounting a display item on a receiving surface with an adhesive layer provided thereon and including a releasable layer disposed over the adhesive layer including first and second flap portions, the method comprising:
separating the second flap portion of the releasable layer from the adhesive using the first flap portion to expose a first region of adhesive;
mounting the display item on the receiving surface using the first region of adhesive;
separating the remainder of the releasable layer from the adhesive using the first or second flap portions to expose a second region of adhesive; and
securing the display item to the receiving surface using the second region of adhesive.

13. The method of claim 12, wherein separating the second flap portion includes:
folding the first and/or second flap portions to provide an elevated region adjacent the first region of adhesive onto which the display item can rest without touching the exposed adhesive of the first region.

14. The method of in claim 12, wherein mounting the display item includes adhering a portion of the item to the first region of adhesive.

15. The method of claim 12, wherein separating the second flap portion includes folding the second flap portion using a perforated region at the boundary of the second flap portion with the remainder of the releasable layer.

16. The method of claim 12, wherein separating the second flap portion of the releasable layer from the adhesive using the first flap portion includes using at least a part of the first flap portion which extends over the periphery of the receiving surface.

17. The method of claim 12, wherein the receiving surface is devoid of the adhesive layer in a boundary region around its periphery.

18. A mount for a display item, comprising:
a substantially rigid substrate including an adhesive layer disposed over a portion of a face thereof;
a releasable layer covering the adhesive and including first and second perforated boundaries defining three portions for the backing layer, at least one arranged to expose a portion of the adhesive layer when separated from the adhesive layer, and wherein one backing layer portion extends over an edge of the face.

19. The mount of claim 18, further comprising a boundary region on the periphery of the substrate which is devoid of the adhesive layer.

20. The mount of claim 18, wherein the at least one portion arranged to expose a portion of the adhesive layer is further arranged to be folded back to provide a raised area for receiving the display item for alignment on the mount.

21. The mount of claim 18, wherein the first perforated boundary is provided on the one backing layer portion which extends over an edge of the face at the edge of the face so that the portion can be folded down over the edge.

22-26. (canceled)
